(19) United States
(12) Patent Application Publication
(10) Pub. No.: US 2022/0092819 A1
(43) Pub. Date: Mar. 24, 2022

(54) METHOD AND SYSTEM FOR CALIBRATING EXTRINSIC PARAMETERS BETWEEN DEPTH CAMERA AND VISIBLE LIGHT CAMERA

(71) Applicant: Xidian University, Xi'an (CN)

(72) Inventors: Guang JIANG, Xi'an (CN); Zixuan BAI, Xi'an (CN); Ailing XU, Xi'an (CN); Jing JIA, Xi'an (CN)

(73) Assignee: Xidian University, Xi'an (CN)

(21) Appl. No.: 17/144,303

(22) Filed: Jan. 8, 2021

(30) Foreign Application Priority Data
Sep. 22, 2020 (CN) 202011000616.0

(51) Int. Cl. G06T 7/80; H04N 17/00; H04N 5/247; G06T 7/50; G06T 7/11

(52) U.S. Cl. CPC G06T 7/80; H04N 17/002; H04N 5/247; G06T 2207/30244; G06T 7/11; G06T 2207/10024; G06T 2207/10028; G06T 7/50

(57) ABSTRACT

A method and system for calibrating extrinsic parameters between a depth camera and a visible light camera. Acquiring depth images and visible light images of the checkerboard plane in different transformation poses; determining visible light checkerboard planes of different transformation poses in a coordinate system of the visible light camera and depth checkerboard planes of different transformation poses in a coordinate system of the depth camera; determining a rotation matrix from the coordinate system of the depth camera to the coordinate system of the visible light camera; determining a translation vector from the coordinate system of the depth camera to the coordinate system of the visible light camera; rotating and translating the coordinate system of the depth camera, so that the coordinate system of the depth camera coincides with the coordinate system of the visible light camera to complete the extrinsic calibration of the dual cameras.

### TECHNICAL FIELD

The present disclosure relates to the technical field of image processing and computer vision, in particular to a method and system for calibrating extrinsic parameters between a depth camera and a visible light camera.

### BACKGROUND

In application scenarios that include environmental perception functions, fusing the depth information and optical information of the environment can improve the intuitive understanding of the environment and bring richer information to the perception of the environment. The depth information of the environment is often provided by a depth camera based on the time-of-flight (ToF) method or the principle of structured light. The optical information is provided by a visible light camera. In the fusion process of the depth information and optical information, the coordinate systems of the depth camera and the visible light camera need to be aligned, that is, the extrinsic parameters between the depth camera and the visible light camera need to be calibrated.

Most of the existing calibration methods are based on point features. The corresponding point pairs in the depth image and the visible light image are obtained by manually selecting points or using a special calibration board with holes or special edges, and then the extrinsic parameters between the depth camera and the visible light camera are calculated through the corresponding points. The point feature-based method requires very accurate point correspondence, but manual point selection will bring large errors and often cannot meet the requirement of this method. The calibration board method has a customization requirement for the calibration board, and the cost is high. In addition, in this method, the user needs to fit the holes or edges in the depth image, but the depth camera has large imaging noise at sharp edges, often resulting in an error between the fitting result and the real position, and leading to low accuracy of the calibration.

### SUMMARY

The present disclosure aims to provide a method and system for calibrating extrinsic parameters between a depth camera and a visible light camera. The present disclosure solves the problem of low accuracy of the extrinsic calibration result of the existing calibration method.

To achieve the above objective, the present disclosure provides the following solutions:

A method for calibrating extrinsic parameters between a depth camera and a visible light camera is applied to a dual camera system, which includes the depth camera and the visible light camera; the depth camera and the visible light camera have a fixed relative pose and compose a camera pair; and the extrinsic calibration method includes:

placing a checkerboard plane in the field of view of the camera pair, and transforming the checkerboard plane in a plurality of poses;

shooting the checkerboard plane in different transformation poses, and acquiring depth images and visible light images of the checkerboard plane in different transformation poses;

determining visible light checkerboard planes of different transformation poses in a coordinate system of the visible light camera according to the visible light images;

determining depth checkerboard planes of different transformation poses in a coordinate system of the depth camera according to the depth images;

determining a rotation matrix from the coordinate system of the depth camera to the coordinate system of the visible light camera according to the visible light checkerboard planes and the depth checkerboard planes;

determining a translation vector from the coordinate system of the depth camera to the coordinate system of the visible light camera according to the rotation matrix; and

rotating and translating the coordinate system of the depth camera according to the rotation matrix and the translation vector, so that the coordinate system of the depth camera coincides with the coordinate system of the visible light camera to complete the extrinsic calibration of the dual cameras.

Optionally, the determining visible light checkerboard planes of different transformation poses in a coordinate system of the visible light camera according to the visible light images specifically includes:

calibrating a plurality of the visible light images by using Zhengyou Zhang's calibration method, and acquiring a first rotation matrix and a first translation vector for transforming a checkerboard coordinate system of each transformation pose to the coordinate system of the visible light camera;

randomly selecting n points that are not collinear on a checkerboard surface in the checkerboard coordinate system for each of the visible light images, n≥3;

transforming the n points to the coordinate system of the visible light camera according to the first rotation matrix and the first translation vector, and determining transformed points;

determining a visible light checkerboard plane of any one of the visible light images according to the transformed points; and

obtaining visible light checkerboard planes of all the visible light images, and determining the visible light checkerboard planes of different transformation poses in the coordinate system of the visible light camera.

Optionally, the determining depth checkerboard planes of different transformation poses in a coordinate system of the depth camera according to the depth images specifically includes:

converting a plurality of the depth images into a plurality of three-dimensional (3D) point clouds in the coordinate system of the depth camera;

segmenting any one of the 3D point clouds, and determining a point cloud plane corresponding to the checkerboard plane;

fitting the point cloud plane by using a plane fitting algorithm, and determining a depth checkerboard plane of any one of the 3D point clouds; and

obtaining the depth checkerboard planes of all the 3D point clouds, and determining the depth checkerboard planes of different transformation poses in the coordinate system of the depth camera.

Optionally, the determining a rotation matrix from the coordinate system of the depth camera to the coordinate system of the visible light camera according to the visible light checkerboard planes and the depth checkerboard planes specifically includes:

determining visible light plane normal vectors corresponding to the visible light checkerboard planes and depth plane normal vectors corresponding to the depth checkerboard planes based on the visible light checkerboard planes and the depth checkerboard planes;

normalizing the visible light plane normal vectors and the depth plane normal vectors respectively, and determining visible light unit normal vectors and depth unit normal vectors; and

determining the rotation matrix according to the visible light unit normal vectors and the depth unit normal vectors.

Optionally, the determining a translation vector from the coordinate system of the depth camera to the coordinate system of the visible light camera according to the rotation matrix specifically includes:

selecting three transformation poses that are not parallel and have an angle between each other from all the transformation poses of the checkerboard planes, and obtaining three of the visible light checkerboard planes and three of the depth checkerboard planes corresponding to the three transformation poses;

acquiring a visible light intersection point of the three visible light checkerboard planes and a depth intersection point of the three depth checkerboard planes; and

determining the translation vector from the coordinate system of the depth camera to the coordinate system of the visible light camera according to the visible light intersection point, the depth intersection point and the rotation matrix.

A system for calibrating extrinsic parameters between a depth camera and a visible light camera, where the extrinsic calibration system is applied to a dual camera system, which includes the depth camera and the visible light camera; the depth camera and the visible light camera have a fixed relative pose and compose a camera pair; the extrinsic calibration system includes:

a pose transformation module, configured to place a checkerboard plane in the field of view of the camera pair, and transform the checkerboard plane in a plurality of poses;

a depth image and visible light image acquisition module, configured to shoot the checkerboard plane in different transformation poses, and acquire depth images and visible light images of the checkerboard plane in different transformation poses;

a visible light checkerboard plane determination module, configured to determine visible light checkerboard planes of different transformation poses in a coordinate system of the visible light camera according to the visible light images;

a depth checkerboard plane determination module, configured to determine depth checkerboard planes of different transformation poses in a coordinate system of the depth camera according to the depth images;

a rotation matrix determination module, configured to determine a rotation matrix from the coordinate system of the depth camera to the coordinate system of the visible light camera according to the visible light checkerboard planes and the depth checkerboard planes;

a translation vector determination module, configured to determine a translation vector from the coordinate system of the depth camera to the coordinate system of the visible light camera according to the rotation matrix; and

a coordinate system alignment module, configured to rotate and translate the coordinate system of the depth camera according to the rotation matrix and the translation vector, so that the coordinate system of the depth camera coincides with the coordinate system of the visible light camera to complete the extrinsic calibration of the dual cameras.

Optionally, the visible light checkerboard plane determination module specifically includes:

a first rotation matrix and first translation vector acquisition unit, configured to calibrate a plurality of the visible light images by using Zhengyou Zhang's calibration method, and acquire a first rotation matrix and a first translation vector for transforming a checkerboard coordinate system of each transformation pose to the coordinate system of the visible light camera;

an n points selection unit, configured to randomly select n points that are not collinear on a checkerboard surface in the checkerboard coordinate system for each of the visible light images, n≥3;

a transformed point determination unit, configured to transform the n points to the coordinate system of the visible light camera according to the first rotation matrix and the first translation vector, and determine transformed points;

an image-based visible light checkerboard plane determination unit, configured to determine a visible light checkerboard plane of any one of the visible light images according to the transformed points; and

a pose-based visible light checkerboard plane determination unit, configured to obtain visible light checkerboard planes of all the visible light images, and determine the visible light checkerboard planes of different transformation poses in the coordinate system of the visible light camera.

Optionally, the depth checkerboard plane determination module specifically includes:

a 3D point cloud conversion unit, configured to convert a plurality of the depth images into a plurality of 3D point clouds in the coordinate system of the depth camera;

a segmentation unit, configured to segment any one of the 3D point clouds, and determine a point cloud plane corresponding to the checkerboard plane;

a point cloud-based depth checkerboard plane determination unit, configured to fit the point cloud plane by using a plane fitting algorithm, and determine a depth checkerboard plane of any one of the 3D point clouds; and a pose-based depth checkerboard plane determination unit, configured to obtain the depth checkerboard planes of all the 3D point clouds, and determine the depth checkerboard planes of different transformation poses in the coordinate system of the depth camera.

Optionally, the rotation matrix determination module specifically includes:

a visible light plane normal vector and depth plane normal vector determination unit, configured to determine visible light plane normal vectors corresponding to the visible light checkerboard planes and depth plane normal vectors corresponding to the depth checkerboard planes based on the visible light checkerboard planes and the depth checkerboard planes;

a visible light unit normal vector and depth unit normal vector determination unit, configured to normalize the visible light plane normal vectors and the depth plane normal vectors respectively, and determine visible light unit normal vectors and depth unit normal vectors; and a rotation matrix determination unit, configured to determine the rotation matrix according to the visible light unit normal vectors and the depth unit normal vectors.

Optionally, the translation vector determination module specifically includes:

a transformation pose selection unit, configured to select three transformation poses that are not parallel and have an angle between each other from all the transformation poses of the checkerboard planes, and obtain three of the visible light checkerboard planes and three of the depth checkerboard planes corresponding to the three transformation poses;

a visible light intersection point and depth intersection point acquisition unit, configured to acquire a visible light intersection point of the three visible light checkerboard planes and a depth intersection point of the three depth checkerboard planes; and

a translation vector determination unit, configured to determine the translation vector from the coordinate system of the depth camera to the coordinate system of the visible light camera according to the visible light intersection point, the depth intersection point and the rotation matrix.

According to the specific embodiments provided in the present disclosure, the present disclosure achieves the following technical effects. The present disclosure provides a method and system for calibrating extrinsic parameters between a depth camera and a visible light camera. The present disclosure directly performs fitting on the entire depth checkerboard plane in the coordinate system of the depth camera, without linear fitting to the edge of the depth checkerboard plane, avoiding noise during edge fitting, and improving the calibration accuracy.

The present disclosure does not require manual selection of corresponding points. The calibration is easy to implement, and the calibration result is less affected by manual intervention and has high accuracy.

The present disclosure uses a common plane board with a checkerboard pattern as a calibration object, which does not require special customization, and has low cost.

### BRIEF DESCRIPTION OF DRAWINGS

To describe the technical solutions in the embodiments of the present disclosure or in the prior art more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method for calibrating extrinsic parameters between a depth camera and a visible light camera according to the present disclosure.

FIG. 2 is a schematic diagram showing a relationship between different transformation poses of a checkerboard and a checkerboard coordinate system according to the present disclosure.

FIG. 3 is a structural diagram of a system for calibrating extrinsic parameters between a depth camera and a visible light camera according to the present disclosure.

### DETAILED DESCRIPTION

The following clearly and completely describes the technical solutions in the embodiments of the present disclosure with reference to accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts should fall within the protection scope of the present disclosure.

An objective of the present disclosure is to provide a method for calibrating extrinsic parameters between a depth camera and a visible light camera. The present disclosure increases the accuracy of the extrinsic calibration result.

To make the above objective, features and advantages of the present disclosure clearer and more comprehensible, the present disclosure is further described in detail below with reference to the accompanying drawings and specific embodiments.

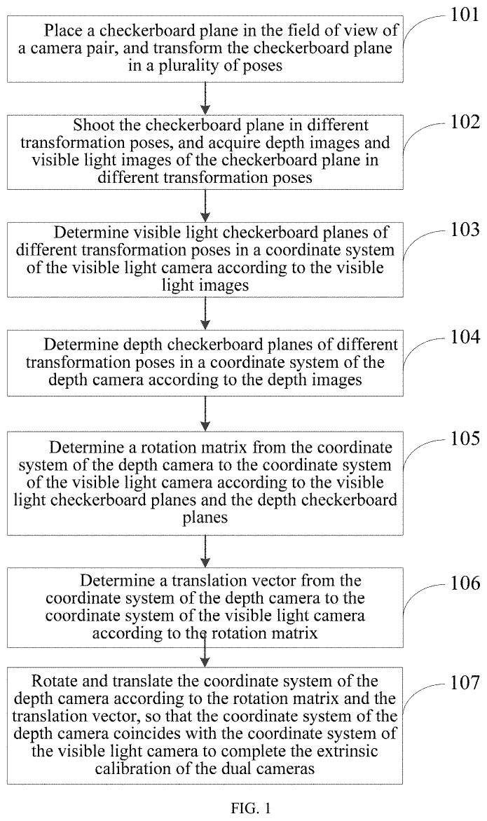

FIG. 1 is a flowchart of a method for calibrating extrinsic parameters between a depth camera and a visible light camera according to the present disclosure. As shown in FIG. 1, the extrinsic calibration method is applied to a dual camera system, which includes the depth camera and the visible light camera. The depth camera and the visible light camera have a fixed relative pose and compose a camera pair. The extrinsic calibration method includes:

Step 101: Place a checkerboard plane in the field of view of the camera pair, and transform the checkerboard plane in a plurality of poses.

The depth camera and the visible light camera are arranged in a scenario, and their fields of view coincide a lot.

Step 102: Shoot the checkerboard plane in different transformation poses, and acquire depth images and visible light images of the checkerboard plane in different transformation poses.

A plane with a black and white checkerboard pattern and a known grid size is placed in the fields of view of the depth camera and the visible light camera, and the relative pose between the checkerboard plane and the camera pair is continuously transformed. During this period, the depth camera and the visible light camera take N (N≥3) shots of the plane at the same time to obtain N pairs of depth images and visible light images of the checkerboard plane in different poses.

Step 103: Determine visible light checkerboard planes of different transformation poses in a coordinate system of the visible light camera according to the visible light images.

N checkerboard planes πᵢ^{C}(i=1, 2, . . . , N) in the coordinate system of the visible light camera are acquired, where the superscript C represents the coordinate system of the visible light camera.

The step 103 specifically includes:

Calibrate N visible light images by using Zhengyou Zhang's calibration method, and acquire a first rotation matrix _{C}^{O}Rᵢ and a first translation vector _{C}^{O}tᵢ(i=1, 2, . . . , N) for transforming a checkerboard coordinate system of each pose to the coordinate system of the visible light camera, where the checkerboard coordinate system is a coordinate system established with an internal corner point on the checkerboard plane as an origin and the checkerboard plane as an xoy plane and changing with the pose of the checkerboard.

Process an i-th visible light image, that is, randomly take at least three points that are not collinear on the checkerboard plane in the checkerboard coordinate system in space, transform these points into the camera coordinate system through a transformation matrix [_{C}^{O}Rᵢ|_{C}^{O}tᵢ], and determine a visible light checkerboard plane πᵢ^{C}:Aᵢ^{C}x+Bᵢ^{C}y+Cᵢ^{C}z+Dᵢ^{C}=0 according to the transformed points.

The first rotation matrix is a matrix with 3 rows and 3 columns, and the first translation vector is a matrix with 3 rows and 1 column. The rotation matrix and the translation vector are horizontally spliced into a rigid body transformation matrix with 3 rows and 4 columns in the form of [R|t]. Points on the same plane are still on the same plane after a rigid body transformation, so at least three points that are not collinear on the checkerboard plane (that is, the xoy plane) of the checkerboard coordinate system are taken. After the rigid body transformation, these points are still on the same plane and not collinear. Since the three non-collinear points define a plane, an equation of the plane after the rigid body transformation can be obtained.

Repeat the above step for each visible light image to obtain all checkerboard planes πᵢ^{C}(i=1, 2, . . . , N) in the coordinate system of the visible light camera, that is, visible light checkerboard planes in different transformation poses.

Step 104: Determine depth checkerboard planes of different transformation poses in a coordinate system of the depth camera according to the depth images.

The step 104 specifically includes:

Acquire N checkerboard planes πⱼ^{D}(j=1, 2, . . . , N) in the coordinate system of the depth camera.

Convert N depth images captured by the depth camera into N three-dimensional (3D) point clouds in the coordinate system of the depth camera.

Process a j-th point cloud, that is, segment the point cloud, obtain a point cloud plane corresponding to the checkerboard plane, and fit the point cloud plane by using a plane fitting algorithm to obtain a depth checkerboard plane πⱼ^{D}:Aⱼ^{D}x+Bⱼ^{D}y+Cⱼ^{D}z+Dⱼ^{D}=0 in the coordinate system of the depth camera.

The specific segmentation is to segment a point cloud that includes the checkerboard plane from the 3D point cloud data. This point cloud is located on the checkerboard plane in the 3D space and can represent the checkerboard plane.

There are many segmentation methods. For example, some software that can process point cloud data can be used to manually select and segment the point cloud. Another method is to manually select a region of interest (ROI) on the depth image corresponding to the point cloud, and then extract the point cloud corresponding to the region. If there are many known conditions, for example, the approximate distance and position of the checkerboard to the depth camera are known, then the point cloud fitting algorithm can also be used to find the plane in the set point cloud region.

Plane fitting algorithms such as least squares (LS) and random sample consensus (RANSAC) can be used to fit the plane.

Repeat the above step for each point cloud to obtain all checkerboard planes πⱼ^{D}(j=1, 2, . . . , N) in the coordinate system of the depth camera, that is, depth checkerboard planes in different transformation poses.

Step 105: Determine a rotation matrix from the coordinate system of the depth camera to the coordinate system of the visible light camera according to the visible light checkerboard planes and the depth checkerboard planes.

The step 105 specifically includes: Solve a rotation matrix R from the coordinate system of the depth camera to the coordinate system of the visible light camera based on the checkerboard planes πᵢ^{D}(j=1, 2, . . . , N) in the coordinate system of the depth camera and the checkerboard planes πᵢ^{C}:Aᵢ^{C}x+Bᵢ^{C}y+Cᵢ^{C}z+Dᵢ^{C}=0 in the coordinate system of the visible light camera, specifically:

Obtain corresponding normal vectors \tilde{c}ⱼ=[Aⱼ^{C} Bᵢ^{C} Cᵢ^{C}]^{T} (i=1, 2, . . . , N) of the checkerboard planes πᵢ^{C}(i=1, 2, . . . , N) in the coordinate system of the visible light camera according to an equation of the checkerboard planes, and normalize the normal vectors of these planes to obtain corresponding unit normal vectors cᵢ(i=1, 2, . . . , N).

Obtain corresponding normal vectors \tilde{d}ⱼ=[Aⱼ^{D} Bⱼ^{D} Cⱼ^{D}]^{T} (j=1, 2, . . . , N) of the checkerboard planes πⱼ^{D}(j=1, 2, . . . , N) in the coordinate system of the depth camera according to an equation of the checkerboard planes, and normalize the normal vectors of these planes to obtain corresponding unit normal vectors dⱼ(j=1, 2, . . . , N).

Solve the rotation matrix R according to R=(CD^{T})(DD^{T})⁻¹ based on a transformation relationship cᵢ=Rdⱼ between unit normal vectors cᵢ and dⱼ when i=j, where C=[c₁ c₂ . . . c_{N}], D=[d₁ d₂ . . . d_{N}].

Step 106: Determine a translation vector from the coordinate system of the depth camera to the coordinate system of the visible light camera according to the rotation matrix.

The step 106 specifically includes: Solve a translation vector t from the coordinate system of the depth camera to the coordinate system of the visible light camera according to the planes πᵢ^{C}(i=1, 2, . . . , N), the planes πᵢ^{D}(i=1, 2, . . . , N) and the rotation matrix R.

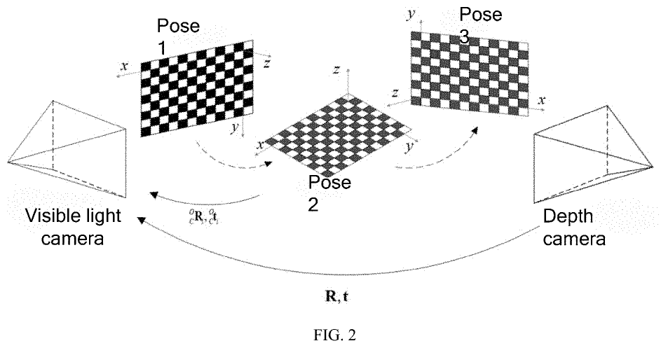

FIG. 2 is a schematic diagram showing a relationship between different transformation poses of a checkerboard and a checkerboard coordinate system according to the present disclosure. As shown in FIG. 2, three poses that are not parallel and have a certain angle between each other are selected from the N checkerboard planes obtained, and the equations of the planes in the coordinate system of the visible light camera and the coordinate system of the depth camera corresponding to these three poses are respectively marked as πₐ^{C}, π_{b}^{C}, πc^{C} and πₐ^{D}, π_{b}^{D} and π_{c}^{D}.

An intersection point p^{C} of planes π^{C}ₐ, π_{b}^{C} and π_{c}^{C} is calculated in the coordinate system of the visible light camera.

An intersection point p^{D} of planes αₐ^{D}, α_{b}^{D} and α_{c}^{D} is calculated in the coordinate system of the depth camera.

According to the rigid body transformation properties between the 3D coordinate systems and the rotation matrix R obtained in step 105, the translation vector t is solved by t=p^{C}−Rp^{D}.

Step 107: Rotate and translate the coordinate system of the depth camera according to the rotation matrix and the translation vector, so that the coordinate system of the depth camera coincides with the coordinate system of the visible light camera to complete the extrinsic calibration of the dual cameras.

The coordinate system of the depth camera is rotated and translated according to the rotation matrix R and the translation vector t, so that the coordinate system of the depth camera coincides with the coordinate system of the visible light camera to complete the extrinsic calibration.

In a practical application, the method of the present disclosure specifically includes the following steps:

Step 1: Arrange a camera pair composed of a depth camera and a visible light camera in a scenario, where the fields of view of the depth camera and the visible light camera coincide a lot, and the relative pose of the two cameras is fixed.

The visible light camera obtains the optical information in the environment, such as color and lighting. The depth camera perceives the depth information of the environment through methods such as time-of-flight (ToF) or structured light, and obtains the 3D data about the environment. As the relative pose of the depth camera and the visible light camera is fixed, the extrinsic parameters between the coordinate systems of the two cameras, that is, the translation and rotation relationships, will not change.

Step 2: Place a checkerboard plane in the field of view of the camera pair, and transform the poses of the checkerboard plane for shooting.

2.1) Place the checkerboard in front of the camera in any pose; when there is a complete checkerboard pattern in the field of view of the visible light camera and the depth camera, take a shot at the same time to obtain a visible light image and a depth image.

2.2) Change the pose of the checkerboard, and repeat 2.1) for N(N≥3) times to obtain N pairs of depth images and visible light images of the checkerboard plane in different poses, where in a specific embodiment, N=25 pairs of images are repeatedly shot.

Step 3: Solve a rotation matrix R based on the plane data obtained by shooting.

3.1) Acquire N checkerboard planes πᵢ^{C}(i=1, 2, . . . , N) in the coordinate system of the visible light camera.

3.1.1) Calibrate N visible light images by using Zhengyou Zhang's calibration method, and acquire a rotation matrix _{C}^{O}Rᵢ and a translation vector _{C}^{O}tᵢ(i=1, 2, . . . , N) for transforming a checkerboard coordinate system of each pose to the coordinate system of the visible light camera.

3.1.2) Process an i-th visible light image, that is, randomly take at least three points that are not collinear on the checkerboard plane in the checkerboard coordinate system in space (in a specific embodiment, points

$$[ \begin{matrix}1 \\ 0 \\ 0 \\ 1\end{matrix} ] , [ \begin{matrix}0 \\ 1 \\ 0 \\ 1\end{matrix} ] and [ \begin{matrix}1 \\ 1 \\ 0 \\ 1\end{matrix} ]$$

are selected), transform these three points into the camera coordinate system through a transformation matrix [_{C}^{O}Rᵢ|_{C}^{O}tᵢ], and obtain a plane equation it πᵢ^{C}:Aᵢ^{c}x+Bᵢ^{C}y+Cᵢ^{C}z+Dᵢ^{C}=0 according to the transformed points based on the principle that three points define a plane.

3.1.3) Repeat 3.1.2) for each visible light image to obtain all checkerboard planes πᵢ^{C}(i=1, 2, . . . , N) in the coordinate system of the visible light camera.

3.2) Acquire N checkerboard planes πⱼ^{p} (j=1, 2, . . . , N) in the coordinate system of the depth camera.

3.2.1) Convert N depth images captured by the depth camera into N 3D point clouds in the coordinate system of the depth camera.

3.2.2) Process a j-th point cloud, that is, segment the point cloud, and obtain a point cloud plane corresponding to the checkerboard plane, where in a specific embodiment, the point cloud plane is fit by using RANSAC algorithm to obtain a depth checkerboard plane πⱼ^{D}:Aⱼ^{D}x+Bⱼ^{D}+Cⱼ^{D}z+Dⱼ^{D}=0 in the coordinate system of the depth camera.

3.2.3) Repeat 3.2.2) for each point cloud to obtain all checkerboard planes πⱼ^{D}(j=1, 2, . . . , N) in the coordinate system of the depth camera.

3.3) Solve a rotation matrix R from the coordinate system of the depth camera to the coordinate system of the visible light camera.

3.3.1) Obtain corresponding normal vectors \tilde{c}ᵢ=[Aᵢ^{C} Bᵢ^{C} Cᵢ^{C}]^{T}(i=1, 2, . . . , N) of the checkerboard planes πᵢ^{C}(i=1, 2, . . . , N) in the coordinate system of the visible light camera according to the equations of the checkerboard planes, and normalize the normal vectors of these planes to obtain corresponding unit normal vectors cᵢ(i=1, 2, . . . , N).

3.3.2) Obtain corresponding normal vectors \tilde{d}ⱼ=[Aⱼ^{D} Bⱼ^{D} Cⱼ^{D}]^{T}(j=1, 2, . . . , N) of the checkerboard planes πⱼ^{D}(j=1, 2, . . . , N) in the coordinate system of the depth camera according to the equations of the checkerboard planes, and normalize the normal vectors of these planes to obtain corresponding unit normal vectors dⱼ(j=1, 2, . . . , N).

3.3.3) Solve the rotation matrix R according to R=(CD^{T})(DD^{T})⁻¹ based on a transformation relationship cᵢ=Rdⱼ between unit normal vectors cᵢ and dⱼ when i=j, where C=[c₁ c₂ . . . c_{N}], D=[d₁ d₂ . . . d_{N}].

Step 4: Solve a translation vector t by using an intersection point of three planes as a corresponding point.

4.1) Select three poses that are not parallel and have a certain angle between each other from the N checkerboard planes obtained, and mark the equations of the planes in the coordinate system of the visible light camera and the coordinate system of the depth camera corresponding to these three poses respectively as πₐ^{C}, π_{b}^{C}, and π_{c}^{C} and πₐ^{D}, π_{b}^{D} and π_{c}^{D}.

4.2) Calculate an intersection point p^{C} of planes πₐ^{C}, π_{b}^{C} and π_{c}^{C} in the coordinate system of the visible light camera by using simultaneous plane equations.

4.3) Calculate an intersection point p^{D} of planes πₐ^{D}, π_{b}^{D} and π_{c}^{D} in the coordinate system of the depth camera by using simultaneous plane equations.

4.4) Solve the translation vector t by t=p^{C}−Rp^{D} according to the rigid body transformation properties between the 3D coordinate systems and the rotation matrix R obtained in 3.3.3).

Step 5: Rotate and translate the coordinate system of the depth camera according to the rotation matrix R and the translation vector t, so that the coordinate system of the depth camera coincides with the coordinate system of the visible light camera to complete the extrinsic calibration.

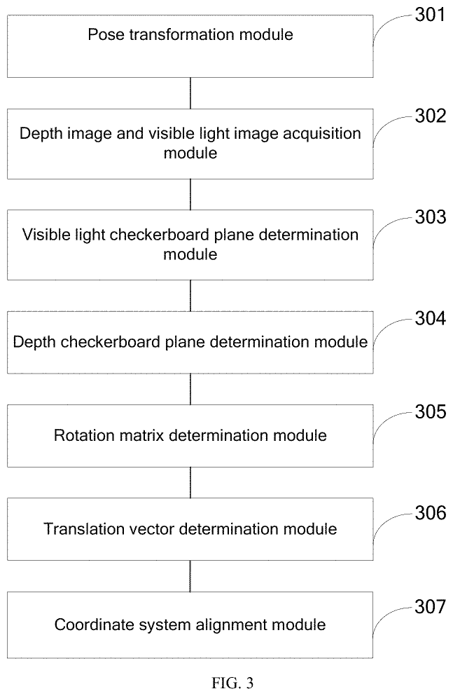

FIG. 3 is a structural diagram of a system for calibrating extrinsic parameters between a depth camera and a visible light camera according to the present disclosure. As shown in FIG. 3, the extrinsic calibration system is applied to a dual camera system, which includes the depth camera and the visible light camera. The depth camera and the visible light camera have a fixed relative pose and compose a camera pair. The extrinsic calibration system includes a pose transformation module, a depth image and visible light image acquisition module, a visible light checkerboard plane determination module, a depth checkerboard plane determination module, a rotation matrix determination module, a translation vector determination module and a coordinate system alignment module.

The pose transformation module 301 is configured to place a checkerboard plane in the field of view of the camera pair, and transform the checkerboard plane in a plurality of poses.

The depth image and visible light image acquisition module 302 is configured to shoot the checkerboard plane in different transformation poses, and acquire depth images and visible light images of the checkerboard plane in different transformation poses.

The visible light checkerboard plane determination module 303 is configured to determine visible light checkerboard planes of different transformation poses in a coordinate system of the visible light camera according to the visible light images.

The visible light checkerboard plane determination module 302 specifically includes:

a first rotation matrix and first translation vector acquisition unit, configured to calibrate a plurality of the visible light images by using Zhengyou Zhang's calibration method, and acquire a first rotation matrix and a first translation vector for transforming a checkerboard coordinate system of each transformation pose to the coordinate system of the visible light camera;

an n points selection unit, configured to randomly select n points that are not collinear on a checkerboard surface in the checkerboard coordinate system for each of the visible light images, n≥3;

a transformed point determination unit, configured to transform the n points to the coordinate system of the visible light camera according to the first rotation matrix and the first translation vector, and determine transformed points;

an image-based visible light checkerboard plane determination unit, configured to determine a visible light checkerboard plane of any one of the visible light images according to the transformed points; and

a pose-based visible light checkerboard plane determination unit, configured to obtain visible light checkerboard planes of all the visible light images, and determine the visible light checkerboard planes of different transformation poses in the coordinate system of the visible light camera.

The depth checkerboard plane determination module 304 is configured to determine depth checkerboard planes of different transformation poses in a coordinate system of the depth camera according to the depth images.

The depth checkerboard plane determination module 304 specifically includes:

a 3D point cloud conversion unit, configured to convert a plurality of the depth images into a plurality of 3D point clouds in the coordinate system of the depth camera;

a segmentation unit, configured to segment any one of the 3D point clouds, and determine a point cloud plane corresponding to the checkerboard plane;

a point cloud-based depth checkerboard plane determination unit, configured to fit the point cloud plane by using a plane fitting algorithm, and determine a depth checkerboard plane of any one of the 3D point clouds; and

a pose-based depth checkerboard plane determination unit, configured to obtain the depth checkerboard planes of all the 3D point clouds, and determine the depth checkerboard planes of different transformation poses in the coordinate system of the depth camera.

The rotation matrix determination module 305 is configured to determine a rotation matrix from the coordinate system of the depth camera to the coordinate system of the visible light camera according to the visible light checkerboard planes and the depth checkerboard planes.

The rotation matrix determination module 305 specifically includes:

a visible light plane normal vector and depth plane normal vector determination unit, configured to determine visible light plane normal vectors corresponding to the visible light checkerboard planes and depth plane normal vectors corresponding to the depth checkerboard planes based on the visible light checkerboard planes and the depth checkerboard planes;

a visible light unit normal vector and depth unit normal vector determination unit, configured to normalize the visible light plane normal vectors and the depth plane normal vectors respectively, and determine visible light unit normal vectors and depth unit normal vectors; and

a rotation matrix determination unit, configured to determine the rotation matrix according to the visible light unit normal vectors and the depth unit normal vectors.

The translation vector determination module 306 is configured to determine a translation vector from the coordinate system of the depth camera to the coordinate system of the visible light camera according to the rotation matrix.

The translation vector determination module 306 specifically includes:

a transformation pose selection unit, configured to select three transformation poses that are not parallel and have an angle between each other from all the transformation poses of the checkerboard planes, and obtain three of the visible light checkerboard planes and three of the depth checkerboard planes corresponding to the three transformation poses;

a visible light intersection point and depth intersection point acquisition unit, configured to acquire a visible light intersection point of the three visible light checkerboard planes and a depth intersection point of the three depth checkerboard planes; and

a translation vector determination unit, configured to determine the translation vector from the coordinate system of the depth camera to the coordinate system of the visible light camera according to the visible light intersection point, the depth intersection point and the rotation matrix.

The coordinate system alignment module 307 is configured to rotate and translate the coordinate system of the depth camera according to the rotation matrix and the translation vector, so that the coordinate system of the depth camera coincides with the coordinate system of the visible light camera to complete the extrinsic calibration of the dual cameras.

The method and system for calibrating extrinsic parameters between a depth camera and a visible light camera provided by the present disclosure increase the accuracy of extrinsic calibration and lower the calibration cost.

Each embodiment of the present specification is described in a progressive manner, each embodiment focuses on the difference from other embodiments, and the same and similar parts between the embodiments may refer to each other. For a system disclosed in the embodiments, since the system corresponds to the method disclosed in the embodiments, the description is relatively simple, and reference can be made to the method description.

In this specification, several specific embodiments are used for illustration of the principles and implementations of the present disclosure. The description of the foregoing embodiments is used to help illustrate the method of the present disclosure and the core ideas thereof. In addition, those of ordinary skill in the art can make various modifications in terms of specific implementations and scope of application in accordance with the ideas of the present disclosure. In conclusion, the content of this specification should not be construed as a limitation to the present disclosure.

What is claimed is:

1. A method for calibrating extrinsic parameters between a depth camera and a visible light camera, wherein the extrinsic calibration method is applied to a dual camera system, which comprises the depth camera and the visible light camera; the depth camera and the visible light camera have a fixed relative pose and compose a camera pair; the extrinsic calibration method comprises:
placing a checkerboard plane in the field of view of the camera pair, and transforming the checkerboard plane in a plurality of poses;
shooting the checkerboard plane in different transformation poses, and acquiring depth images and visible light images of the checkerboard plane in different transformation poses;
determining visible light checkerboard planes of different transformation poses in a coordinate system of the visible light camera according to the visible light images;
determining depth checkerboard planes of different transformation poses in a coordinate system of the depth camera according to the depth images;
determining a rotation matrix from the coordinate system of the depth camera to the coordinate system of the visible light camera according to the visible light checkerboard planes and the depth checkerboard planes;
determining a translation vector from the coordinate system of the depth camera to the coordinate system of the visible light camera according to the rotation matrix; and
rotating and translating the coordinate system of the depth camera according to the rotation matrix and the translation vector, so that the coordinate system of the depth camera coincides with the coordinate system of the visible light camera to complete the extrinsic calibration of the dual cameras.

2. The method for calibrating extrinsic parameters between a depth camera and a visible light camera according to claim 1, wherein the determining visible light checkerboard planes of different transformation poses in a coordinate system of the visible light camera according to the visible light images specifically comprises:
calibrating a plurality of the visible light images by using Zhengyou Zhang's calibration method, and acquiring a first rotation matrix and a first translation vector for transforming a checkerboard coordinate system of each transformation pose to the coordinate system of the visible light camera;
randomly selecting n points that are not collinear on a checkerboard surface in the checkerboard coordinate system for each of the visible light images, n≥3;
transforming the n points to the coordinate system of the visible light camera according to the first rotation matrix and the first translation vector, and determining transformed points;
determining a visible light checkerboard plane of any one of the visible light images according to the transformed points; and
obtaining visible light checkerboard planes of all the visible light images, and determining the visible light checkerboard planes of different transformation poses in the coordinate system of the visible light camera.

3. The method for calibrating extrinsic parameters between a depth camera and a visible light camera according to claim 1, wherein the determining depth checkerboard planes of different transformation poses in a coordinate system of the depth camera according to the depth images specifically comprises:
converting a plurality of the depth images into a plurality of three-dimensional (3D) point clouds in the coordinate system of the depth camera;
segmenting any one of the 3D point clouds, and determining a point cloud plane corresponding to the checkerboard plane;
fitting the point cloud plane by using a plane fitting algorithm, and determining a depth checkerboard plane of any one of the 3D point clouds; and
obtaining the depth checkerboard planes of all the 3D point clouds, and determining the depth checkerboard planes of different transformation poses in the coordinate system of the depth camera.

4. The method for calibrating extrinsic parameters between a depth camera and a visible light camera according to claim 1, wherein the determining a rotation matrix from the coordinate system of the depth camera to the coordinate system of the visible light camera according to the visible light checkerboard planes and the depth checkerboard planes specifically comprises:
determining visible light plane normal vectors corresponding to the visible light checkerboard planes and depth plane normal vectors corresponding to the depth checkerboard planes based on the visible light checkerboard planes and the depth checkerboard planes;
normalizing the visible light plane normal vectors and the depth plane normal vectors respectively, and determining visible light unit normal vectors and depth unit normal vectors; and
determining the rotation matrix according to the visible light unit normal vectors and the depth unit normal vectors.

5. The method for calibrating extrinsic parameters between a depth camera and a visible light camera according to claim 4, wherein the determining a translation vector from the coordinate system of the depth camera to the coordinate system of the visible light camera according to the rotation matrix specifically comprises:
selecting three transformation poses that are not parallel and have an angle between each other from all the transformation poses of the checkerboard planes, and obtaining three of the visible light checkerboard planes and three of the depth checkerboard planes corresponding to the three transformation poses;
acquiring a visible light intersection point of the three visible light checkerboard planes and a depth intersection point of the three depth checkerboard planes; and
determining the translation vector from the coordinate system of the depth camera to the coordinate system of the visible light camera according to the visible light intersection point, the depth intersection point and the rotation matrix.

6. A system for calibrating extrinsic parameters between a depth camera and a visible light camera, wherein the extrinsic calibration system is applied to a dual camera system, which comprises the depth camera and the visible light camera; the depth camera and the visible light camera have a fixed relative pose and compose a camera pair; the extrinsic calibration system comprises:
a pose transformation module, configured to place a checkerboard plane in the field of view of the camera pair, and transform the checkerboard plane in a plurality of poses;
a depth image and visible light image acquisition module, configured to shoot the checkerboard plane in different transformation poses, and acquire depth images and visible light images of the checkerboard plane in different transformation poses;
a visible light checkerboard plane determination module, configured to determine visible light checkerboard planes of different transformation poses in a coordinate system of the visible light camera according to the visible light images;
a depth checkerboard plane determination module, configured to determine depth checkerboard planes of different transformation poses in a coordinate system of the depth camera according to the depth images;
a rotation matrix determination module, configured to determine a rotation matrix from the coordinate system of the depth camera to the coordinate system of the visible light camera according to the visible light checkerboard planes and the depth checkerboard planes;
a translation vector determination module, configured to determine a translation vector from the coordinate system of the depth camera to the coordinate system of the visible light camera according to the rotation matrix; and
a coordinate system alignment module, configured to rotate and translate the coordinate system of the depth camera according to the rotation matrix and the translation vector, so that the coordinate system of the depth camera coincides with the coordinate system of the visible light camera to complete the extrinsic calibration of the dual cameras.

7. The system for calibrating extrinsic parameters between a depth camera and a visible light camera according to claim 6, wherein the visible light checkerboard plane determination module specifically comprises:
a first rotation matrix and first translation vector acquisition unit, configured to calibrate a plurality of the visible light images by using Zhengyou Zhang's calibration method, and acquire a first rotation matrix and a first translation vector for transforming a checkerboard coordinate system of each transformation pose to the coordinate system of the visible light camera;
an n points selection unit, configured to randomly select n points that are not collinear on a checkerboard surface in the checkerboard coordinate system for each of the visible light images, n≥3;
a transformed point determination unit, configured to transform the n points to the coordinate system of the visible light camera according to the first rotation matrix and the first translation vector, and determine transformed points;
an image-based visible light checkerboard plane determination unit, configured to determine a visible light checkerboard plane of any one of the visible light images according to the transformed points; and
a pose-based visible light checkerboard plane determination unit, configured to obtain visible light checkerboard planes of all the visible light images, and determine the visible light checkerboard planes of different transformation poses in the coordinate system of the visible light camera.

8. The method for calibrating extrinsic parameters between a depth camera and a visible light camera according to claim 6, wherein the depth checkerboard plane determination module specifically comprises:
a 3D point cloud conversion unit, configured to convert a plurality of the depth images into a plurality of 3D point clouds in the coordinate system of the depth camera;
a segmentation unit, configured to segment any one of the 3D point clouds, and determine a point cloud plane corresponding to the checkerboard plane;
a point cloud-based depth checkerboard plane determination unit, configured to fit the point cloud plane by using a plane fitting algorithm, and determine a depth checkerboard plane of any one of the 3D point clouds; and
a pose-based depth checkerboard plane determination unit, configured to obtain the depth checkerboard planes of all the 3D point clouds, and determine the depth checkerboard planes of different transformation poses in the coordinate system of the depth camera.

9. The system for calibrating extrinsic parameters between a depth camera and a visible light camera according to claim 6, wherein the rotation matrix determination module specifically comprises:
a visible light plane normal vector and depth plane normal vector determination unit, configured to determine visible light plane normal vectors corresponding to the visible light checkerboard planes and depth plane normal vectors corresponding to the depth checkerboard planes based on the visible light checkerboard planes and the depth checkerboard planes;
a visible light unit normal vector and depth unit normal vector determination unit, configured to normalize the visible light plane normal vectors and the depth plane normal vectors respectively, and determine visible light unit normal vectors and depth unit normal vectors; and
a rotation matrix determination unit, configured to determine the rotation matrix according to the visible light unit normal vectors and the depth unit normal vectors.

10. The system for calibrating extrinsic parameters between a depth camera and a visible light camera according to claim 9, wherein the translation vector determination module specifically comprises:
a transformation pose selection unit, configured to select three transformation poses that are not parallel and have an angle between each other from all the transformation poses of the checkerboard planes, and obtain three of the visible light checkerboard planes and three of the depth checkerboard planes corresponding to the three transformation poses;
a visible light intersection point and depth intersection point acquisition unit, configured to acquire a visible light intersection point of the three visible light checkerboard planes and a depth intersection point of the three depth checkerboard planes; and
a translation vector determination unit, configured to determine the translation vector from the coordinate system of the depth camera to the coordinate system of the visible light camera according to the visible light intersection point, the depth intersection point and the rotation matrix.
